(19) United States
(12) Patent Application Publication
(10) Pub. No.: US 2004/0045958 A1
(43) Pub. Date: Mar. 11, 2004

(54) Tn appliance for the equalisation of heat in a dielectric load heated by an oscillating electric/electromagnetic field

(76) Inventor: Lars S.E. Ekemar, Gnesta (SE)

Correspondence Address: Christopher J Fildes, Fildes & Outland, Suite 2, 20916 Mack Avenue, Gross Pointe Woods, MI, 48236, US

(21) Appl. No.: 10/451,971

(22) PCT Filed: Jan. 8, 2002
(86) PCT No.: PCT/SE02/00016

(30) Foreign Application Priority Data
Jan. 8, 2001 (SE) 0100051-2

(51) Int. Cl. H05B 6/62

(52) U.S. Cl. 219/772

(57) ABSTRACT

This invention solves the problem with the overheatings of perishable dielectric matters. The invention is intended for the warming and/or the heating of dielectric matters, which are placed in oscillating electric and/or electromagnetic fields generated at frequencies being below 900 MHz between capacitor discs or in cavities.

It is well known that dielectric matters can be heated by oscillating electric and/or electromagnetic fields. Microwaves, which are generated in a resonant cavity, are most frequently used kind of fields. As a rule micro waves are defined as electric/electromagnetic fields oscillating at frequencies exceeding 900 MHz, still better at frequencies exceeding 400 MHz and best of all at frequencies exceeding 300 MHz.

The disadvantage of microwaves is that the heating usually takes place ia a surface zone, where the energy is focused to so called hot spots.

Oscillating electric/electromagnetic fields at frequencies below microwave frequencies are generally generated between two capacitor discs. Dielectric matters are placed in the air space between the discs, It is of frequent occurrence that heating between capacitor discs is disturbed by the formation of sparks.

This can be avoided by coating the capacitor discs with electrically isolating materials having small values on their dielectricity constant and loss factors implying no or little influence on the electric field. Simultaneously the isolating material shall be characterised by a high electric penetration resistance (EP 85319, U.S. Pat. No. 551,273)

It is also known that the addition of dielectric substances influences the dielectric properties of the load, which is to be heated. (U.S. Pat. No. 5,886,081, U.S. Pat. No. 4,790,965)

A drawback tied to dielectric heating is that the field lines are concentrated to relatively defined areas of the load so that these areas become unequally heated, which implies local heat concentration as a consequence. Especially this is valid, if the load has marked edges and/or protrusive parts. Thus there is a serious problem, if the load to be warmed is perishable to any kind of overheating. An example representing a living matter is a concentrate of red blood cells kept in a bag and meant for intravenous transfusion.

Methods designed for a slow warming of blood have been developed partly by utilising convection. (U.S. Pat. No. 4,167,663) and by partly by utilising microwaves, which at low power warm blood in the course of a transfusion (WO 9926690). The power, which is applied to the warming of blood in accordance to WO 9926690, is so low, that the problem tied to an uneven field distribution is negligible. However methods suitable for the fast warming of perishable loads are lacking.

Bags holding red blood cell concentrates to be used for intravenous transfusion are in general stored in refrigerators at 4° C. Two problems exist as a consequence of this temperature as a blood concentrate is viscous and cold.

It takes long time to get it out of a bag. Thus a blood transfusion will be retarded

Before a blood concentrate is transfused intravenously to a patient it has to be warmed, best of all to body temperature. At acute transfusion occasions, efforts are tried to attain rapid warming of bags holding blood concentrate, in general with water-baths. Such a warming process is in spite of all pains time wasting and as a consequence patients do not receive their transfusions in due course of time.

If for example a patient is in a state if chock owing to an accident, a cooling caused by the transfusion entails a danger of life of the patient.

Experiments implying the rapid warming of bags with blood concentrates by applying micro waves as well as traditional capacitive warming have caused local overheating damages, particularly in surface zones and comers. These damages have occurred in form of coagulated blood parts and have had as consequences that patients have died owing to clots of blood.

When dielectric heating is used, this invention is a solution of the problem with overheating in surface zones and protruding parts.

This is particularly valid if the load is placed in an oscillating electric/and or electromagnetic field being below a micro wave frequency and if the load is not placed in a cavity, which is resonant or becomes resonant owing to the fact it is wholly or partially filled with dielectric matters. An applied frequency shall be below 900 MHz, still better below 400 MHz and best of all be below 300 MHz.

A dielectric load has a dielectricity constant (ε) and so called loss factor tan(γ). ε and tan(γ) are dependent of frequency f and of the kind of matter. It is an adopted practice to specify the heat generation in a matter with the expression:

E²×ε×tan(γ)×f×K

E stands for electric field strength. K is a constant.

The electric field strength is dependent of the dielectricity constant. A load with a dielectricity constant (ε) higher than the one for air located in an electric/electromagnetic field holds a field strength that is lower than the one in the surrounding air.

In the borderline between air and load there are field line patterns, which, if the load has a loss factor at applied frequency, cause local superficial overheating/s in the load.

In order to eliminate this kind of overheating/s the disturbing patterns of field lines must be reduced or best of all eliminated. A prerequisite to reach now mentioned reduction or elimination is, that the difference between (ε) of the load and (ε) of its surrounding material is small. The ideal solution is characterised of an (ε) which is the same for the load and for the surrounding material, simultaneously as the surrounding material entirely has no tan(γ). In these circumstances no local overheating will be possible to take place in those zones, where the material and the load adjoin each other.

In order to achieve requisite shielding effects in local parts of a load a condition is, that at least 20% of the area of the load adjoins the above mentioned material, that still better at least 40% of the area of the adjoins the above mentioned material.

For the purpose of applying the principle of field levelling effectively the material surrounding a load has to be sufficiently thick.

The thickness of the material shall in average not be below 2 mm, still better not be below 5 mm and best of all not be below 8 mm.

The basis of this invention is that a dielectric load having both an (ε) and a tan(γ), wholly or partially is covered of a material, which merely has a dielectricity constant (ε). The material in question may consist of one or more substances.

It has been confirmed that a necessary acceptable reduction of local overheating follows, if the dielectricity constant (ε) of the covering material exceeds 20% of the average (ε) of the load, still better exceeds 40% of the average (ε) of the load and best of all exceeds 60% of the average (ε) of the load.

However, there is no substance, which entirely lacks tan(γ). In order to avoid an unwanted warming of material, which wholly or partially encloses the load, it has been shown in practice that the mean quantity of tan(γ) at applied frequency/cies of the substance the said material consists of shall be at 75% below the mean quantity of the tan(γ) of the load, still better be at 50% below the mean quantity of the tan(γ) of the load and best of all be at 25% below the mean quantity of the tan(γ) of the load.

If a load with a surrounding material is located within an oscillating electric and/or electromagnetic field complicated disturbing field line patterns in the borderland between the material in question and the surrounding air arise. However, in the borderland between the load and the covering material the field line patterns are evened and thus local superficial warming is avoided.

There are certain applications where it may be favourable, if the load only partially is covered of a material, which eliminates or reduces superficial warming. For example if it is desirable to get additional warming of a particular part of a surface.

A low or non existing loss factor implies, that the energy loss in the material, which even the field lines in the surface layer of the load, becomes small or none.

An applicable solution of the problem to warm a load consisting of one ore more substances is that the load in a vessel, which is accordance with the invention holds above mentioned material, which in its turn surrounds the load wholly or partially.

The vessel with its load is placed wholly or partially in an oscillating electric and/or electromagnetic field The disturbing field line patterns, which earlier arose in the surface zones of the load, arise instead in the surface zones of the surrounding material. This implies that the load can be warmed without any local overheating in the surface zones of the load.

A useful application is, that the vessel consists of a tube and/or groove, wholly or partially filled with the above mentioned material. The material is preferably in a liquid state. The tube/groove are wholly or partially placed in the electric and/or electromagnetic field. The dielectric load to be warmed is brought by way of the tube/groove into and/or through the electric/electromaetic field.

The complex disturbing field line patterns, which earlier arose in the surface layer of the load, arise instead in the surface of the above-mentioned material. This implies that the load can be warmed without local overheatings in its surface layer when passing through the material in the vessel.

There is also a need to control the warming of loads to particular zones. Thus the above mentioned material in the vessel can have instead of a homogeneous distribution an inhomogeneous distribution of (ε) and tan(γ).

An example of the invention is the warming of a bag filled with blood concentrate. The bag is placed in a vessel consisting of polyethylene plastic. In this case the load consisted of the blood concentrate with the enclosing bag. The vessel was filled with distilled water. An oscillating electric and electromagnetic field of the frequency 135 MHz supplied a power of about 500 W.

The bag with its content was warmed from 5° C. to 35° C. in a time less than 5 minutes without any blood cells being hurt.

A further example of warming was to get a blood concentrate/liquid to flow from a bag to receptacle outside the warming unit through a tube, which was extended through a vessel filled with distilled water. The vessel was placed in an oscillating electric /electromagnetic field. In this case the load consisted of that part of the tube, which was within the vessel including that part of the flowing blood concentrate the tube contained.

1. An appliance for the equalisation of electric and/or electromagnetic fields being below 900 MHz, where the field/s is/are not generated in a resonant cavity characterized by a dielectric load consisting of one or more matters with a dielectricity constant/s and a loss factor/s being placed in a material/s, the average dielectricity constant of this material/s shall at applied frequency/ies exceed 20% of the average dielectricity constant of the load.

2. An appliance in accordance with claim 1 characterized by the above material/s having an average loss factor at applied frequency/ies being below 75% of the average loss factor of the load.

3. An appliance in accordance with claim 1 and 2 characterized by at least 20% of the surface of the load adjoining and being in contact with the above mentioned material/s.

4. An appliance in accordance with anyone of the above claims characterized by the thickness of the above mentioned material/s in the area/s being in contact with the load in average not being below 2 mm.

5. An appliance in accordance with anyone of the above claims characterized by the load being placed in a vessel containing the above mentioned material/s.

6. An appliance in accordance with anyone of the above claims characterized by the sides of the vessel consisting of the above mentioned material/s.

7. An appliance in accordance with anyone of the above claims characterized by the vessel with load being placed wholly or partially in one or more oscillating electric and/or electromagnetic field/s.

8. An appliance in accordance with anyone of the above claims characterized by the vessel being a tube and/or a groove containing the above mentioned materials and the load.

9. An appliance in accordance with anyone of the above claims characterized by the above mentioned material/s being preferably in a liquid state.

10. An appliance in accordance with anyone of the above claims characterized by the tube/groove wholly or partially being placed in the electric and/or electromagnetic field/s.

11. An appliance in accordance with anyone of the above claims characterized by the dielectric matter/s to be warmed being brought by way of a tube/groove into and/or through the electric and/or electromagnetic field/s.

12. An appliance in accordance with anyone of the above claims characterized by the blood concentrate/liquid flowing to a receptacle through a tube extended through a vessel filled with the above mentioned material and the vessel wholly or partially in the electric and/or electromagnetic field/s.
